(19) United States
(12) Patent Application Publication
(10) Pub. No.: US 2026/0323441 A1
(43) Pub. Date: Oct. 15, 2026

(54) USING A MACHINE LEARNING MODEL TO SELECT A HANDOVER MECHANISM IN A RADIO ACCESS NETWORK

(71) Applicant: Dell Products L.P., Round Rock, TX (US)

(72) Inventor: Prashanth Murthy, Plano, TX (US)

(21) Appl. No.: 19/177,413

(22) Filed: Apr. 11, 2025

(51) Int. Cl. H04W 36/08; H04L 41/16; H04W 28/26; H04W 36/18

(52) U.S. Cl. CPC H04W 36/08; H04L 41/16; H04W 28/26; H04W 36/185

(57) ABSTRACT

The technologies described herein are generally directed to using a machine learning model to select from different mechanisms used to perform handovers between source and target base stations. For instance, a system can identify state information corresponding to a user equipment and a first base station. The system may further, based on the state information, utilize a machine learning model to identify reassignment parameters applicable to a reassignment of the user equipment from the first base station to a second base station. The system may further confirm the reassignment based on a selected reassignment parameter selected from the reassignment parameters.

### BACKGROUND

Modern approaches to handling handovers in radio access networks may utilize different metrics to select from different mechanisms and configurations. Different metrics may be used to determine different handover approaches, by base stations and mobile devices.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include identifying state information corresponding to a user equipment and a first base station. The method may further include, based on the state information, utilizing a machine learning model to identify reassignment parameters applicable to a reassignment of the user equipment from the first base station to a second base station. The method may further include confirming the reassignment based on a selected reassignment parameter selected from the reassignment parameters.

Additionally or alternatively, the state information may include an indication to perform the reassignment. Additionally or alternatively, the respective reassignment parameters may include a respective handover parameter applicable to the reassignment, and wherein the selected reassignment parameter may include the handover parameter. Additionally or alternatively, the handover parameter may include at least one of, a baseline handover parameter, a dual active protocol stack handover parameter, a conditional handover parameter, and a handover parameter triggered by measurement at a communication layer. Additionally or alternatively, the respective reassignment parameters may further include a respective probability of success of the respective reassignment parameter. Additionally or alternatively, the handover parameter was selected based on the probability of success of the handover parameter. Additionally or alternatively, the respective reassignment parameters further may include a respective predicted duration of the reassignment based on an employment of the respective handover parameter applicable to the reassignment. Additionally or alternatively, the selected reassignment parameter was selected further based on the predicted duration of the reassignment.

Additionally or alternatively, based on the predicted duration of the reassignment, reserving, by the computer equipment, a supplemental network resource applicable to supporting the user equipment during the reassignment. Additionally or alternatively, the predicted duration of the reassignment may correspond to a duration from a time the selected reassignment parameter is selected to a completion of the reassignment. Additionally or alternatively, the selected reassignment parameter was selected further based on, a quality of service requirement applicable to communication subject to the reassignment, and the predicted duration of the reassignment being within the quality of service requirement.

Additionally or alternatively, the selected reassignment parameter was selected further based on a determination that the user equipment had a capability to utilize the selected reassignment parameter. Additionally or alternatively, the state information may include at least one of, a first characteristic representative of a source cell identifier of the first base station, a second characteristic representative of a signal-to-noise ratio, a third characteristic representative of a reference signal received power of the first base station, a fourth characteristic representative of a signal-to-interference-plus-noise ratio, a fifth characteristic representative of a characteristic representative of a measurement event threshold, a sixth characteristic representative of a characteristic representative of a time-to-trigger, a seventh characteristic representative of a reference signal received power threshold, an eighth characteristic representative of hysteresis, a ninth characteristic representative of a measured bandwidth, a tenth characteristic representative of transmission power of the user equipment, an eleventh characteristic representative of a channel quality indicator, a twelfth characteristic representative of a timing advance feedback indicator, a thirteenth characteristic representative of a target cell identifier, a fourteenth characteristic representative of a reference signal received power of the second base station, and a fifteenth characteristic representative of a number of candidate cells.

An example system can operate as follows. At least one memory may store computer executable instructions, and at least one processor may be configured to process the computer executable instructions that, when executed by the at least one processor, facilitate performance of operations. The operations may include receiving, from a cellular node of a radio access network, a handover request applicable to a handover of a mobile node from the cellular node to a target cellular node based on a parameter applicable to the handover, and a machine learning structure applicable to the handover. The operations may further include, based on a parameter applicable to the handover, and a machine learning structure applicable to the handover: selecting a collection of reassignment processes for the handover, generating a respective likelihood of a successful handover applicable to the respective reassignment processes, and predicting a respective length of time applicable to completion of the respective reassignment processes. The operations may further include, based on a received indication applicable to the handover, modifying the machine learning structure.

Additionally or alternatively, the machine learning structure may include a machine learning structure that was trained based on historical data of the radio access network applicable to uses of the collection of reassignment processes. Additionally or alternatively, the operations may further include receiving the machine learning structure from core management equipment of the radio access network. Additionally or alternatively, the machine learning structure may include multi-output neural network comprising a classifier and a regressor, with the generating of the respective likelihood of the successful handover including employing the classifier to generate the respective likelihoods, and the predicting of the respective length of time applicable to the respective handover mechanisms including employing the regressor to predict the respective lengths of time.

Additionally or alternatively, the received indication may include weight magnitude data, with the modifying of the machine learning structure including further training the machine learning structure based on the weight magnitude data, and the received indication being received from at least one of the cellular node, the target cellular node, and the mobile node. Additionally or alternatively, the received indication may include information representative of a result of the cellular node employing a selected reassignment process of the collection of reassignment processes, with the cellular node selected the selected reassignment process being based on at least one of, the respective likelihood of the successful handover generated for the selected reassignment process, and the respective length of time predicted for the completion of the selected reassignment process.

An example non-transitory machine-readable medium may include executable instructions that, when executed by at least one processor of base station equipment, facilitate performance of operations. The operations may include identifying a condition applicable to a transition of a user device from a first connection to the base station equipment to a second connection to another base station equipment other than the base station equipment. The operations may further include, based on the condition, selecting a transition mechanism to cause the transition, resulting in a selected transition mechanism, with the selected transition mechanism being selected based on a sampling of a machine learning model that was trained based on historical data of transitions within radio access networks. The operations may further include, based on the selected transition mechanism, causing the transition of the user device from the first connection to the second connection. Additionally or alternatively, the machine learning model may include a feed forward neural network.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate using a machine learning model to select from different mechanisms used to perform handovers between source and target base stations, in accordance with one or more embodiments;

FIG. 2 is an architecture diagram of an example system that can facilitate using a machine learning model to select from different mechanisms used to perform handovers between source and target base stations, in accordance with one or more embodiments;

FIG. 3 is a signaling diagram of an example system that can facilitate using a machine learning model to select from different mechanisms used to perform handovers between source and target base stations, in accordance with one or more embodiments;

FIG. 4 is a diagram of an example system that can facilitate using a machine learning model to select from different mechanisms used to perform handovers between source and target base stations, in accordance with one or more embodiments;

FIG. 5 includes example pseudocode that may be used by embodiments to facilitate using a machine learning model to select from different mechanisms used to perform handovers between source and target base stations, in accordance with one or more embodiments;

FIG. 6 depicts a flow diagram representing example operations of an example method that can facilitate using a machine learning model to select from different mechanisms used to perform handovers between source and target base stations, in accordance with one or more embodiments;

FIG. 7 depicts an example system that can facilitate using a machine learning model to select from different mechanisms used to perform handovers between source and target base stations, in accordance with one or more embodiments;

FIG. 8 depicts an example non-transitory machine-readable medium that can include executable instructions that, when executed by a processor of a system, can facilitate using a machine learning model to select from different mechanisms used to perform handovers between source and target base stations, in accordance with one or more embodiments;

FIG. 9 is a schematic block diagram of a system with which the disclosed subject matter can interact; and

FIG. 10 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

By utilizing one or more implementations as described herein, the performance, efficiency, and management of wireless access point systems may be improved, e.g., by providing approaches to select from different mechanisms for performing user equipment handover operations. Missed or less efficient handover procedures may cause wasted network resources. One or more embodiments described herein are not abstract concepts; rather, they provide technical solutions to technical problems associated with automated radio resource management (RRM) of radio access network resources, technical solutions to technical problems that are inextricably tied to computer systems and computer networks. For example, generally speaking, one or more embodiments may increase the likelihood that a handover between base stations will be successful. Moreover, implementations described herein can provide these solutions in a manner that cannot reliably be performed by a human or even a plurality of humans, e.g., solutions may require rapid and complex processing operations that facilitate wireless networks.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

Generally speaking, one or more embodiments may use measured quantities and user equipment-specific parameters to train a global neural network model that can then be used for inferencing during the handover decision making process (also interchangeably termed reassignment, HO, hand over, and transition, herein).

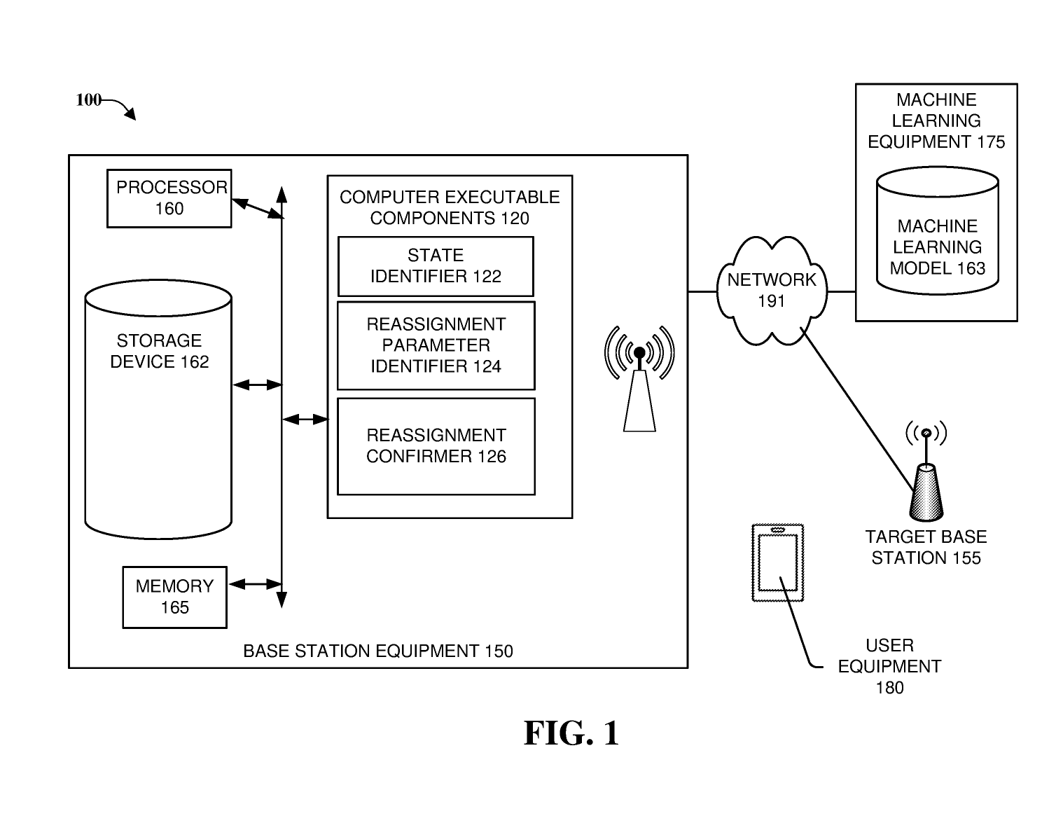

FIG. 1 is an architecture diagram of an example system 100 that can facilitate using a machine learning model to select from different mechanisms used to perform handovers between source and target base stations, in accordance with one or more embodiments. For purposes of brevity, description of like elements and/or processes employed in other embodiments is omitted. As depicted, system 100 includes base station equipment 150 connected, via network 191, to machine learning equipment 175 and target base station 155. User equipment (UE) 180 is depicted, described below as initially connected to base station equipment 150.

As used herein, the terms “network device,” “access point (AP),” “base station,” “NodeB,” “evolved Node B (eNodeB),” “home Node B (HNB),” “home access point (HAP),” “cell device,” “sector,” “cell,” “cellular node,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

As depicted, base station equipment 150 can include memory 165 that can store one or more computer and/or machine readable, writable, and/or executable components 120 and/or instructions. In embodiments, base station equipment 150 can further include processor 160. In one or more embodiments, computer executable components 120, when executed by processor 160, can facilitate performance of operations defined by the executable component(s) and/or instruction(s). Computer executable components 120 can include state identifier 122, reassignment parameter identifier 124, reassignment confirmer 126, and other components described or suggested by different embodiments described herein, that can improve the operation of system 100. Base station equipment 150 may further include storage device 162. In an example, storage device 162 may provide nonvolatile storage of data, data structures, machine learning structures, computer executable instructions, and so forth.

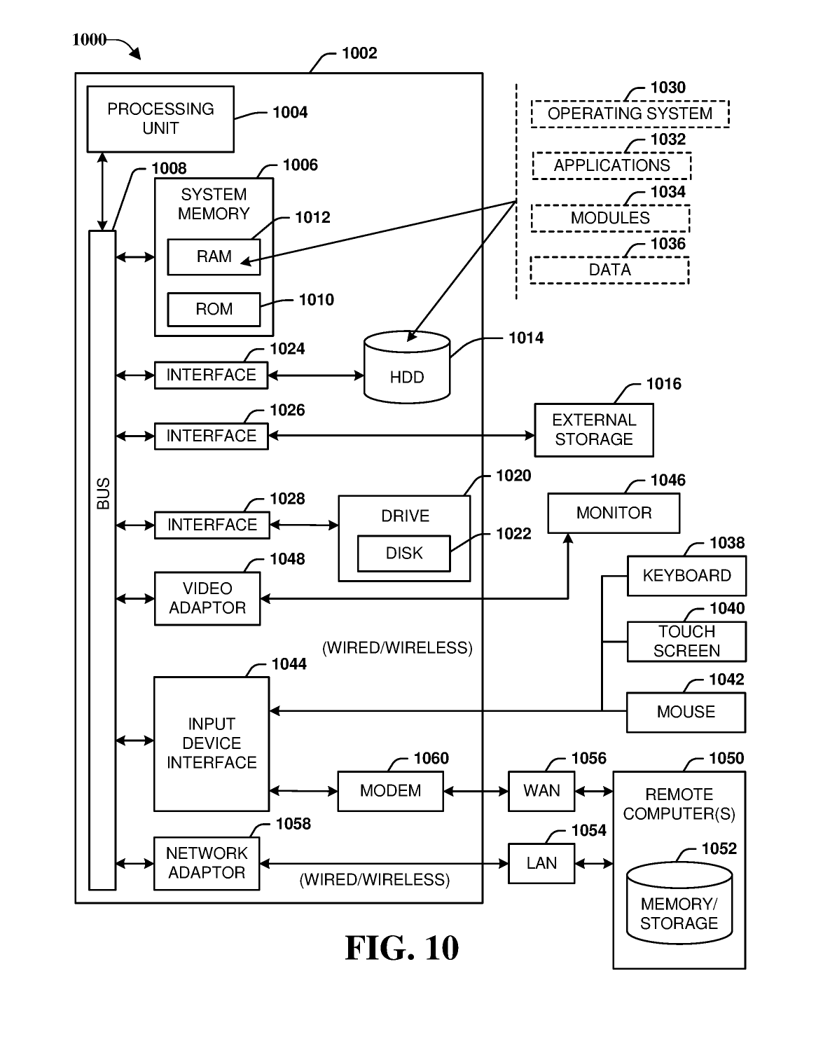

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of state identifier 122, which can in some implementations can identify state information corresponding to a user equipment and a first base station. For example, in one or more embodiments, state identifier 122 may identify state information corresponding to user equipment 180 and base station equipment 150.

In another example, memory 165 can store executable instructions that can facilitate generation of reassignment parameter identifier 124, which in some implementations may, based on the state information, utilize a machine learning model to identify reassignment parameters applicable to a reassignment of the user equipment from the first base station to a second base station. For example, in one or more embodiments, reassignment parameter identifier 124 can, based on the state information, utilize a machine learning model 163 to identify reassignment parameters applicable to a reassignment of user equipment 180 from base station equipment 150 to target base station 155.

In another example, memory 165 can store executable instructions that can facilitate generation of reassignment confirmer 126, which in some implementations may confirm the reassignment based on a selected reassignment parameter selected from the reassignment parameters. For example, in one or more embodiments, reassignment confirmer 126 may confirm the reassignment based on a selected reassignment parameter selected from the reassignment parameters employed to reassign user equipment 180 from base station equipment 150 to target base station 155.

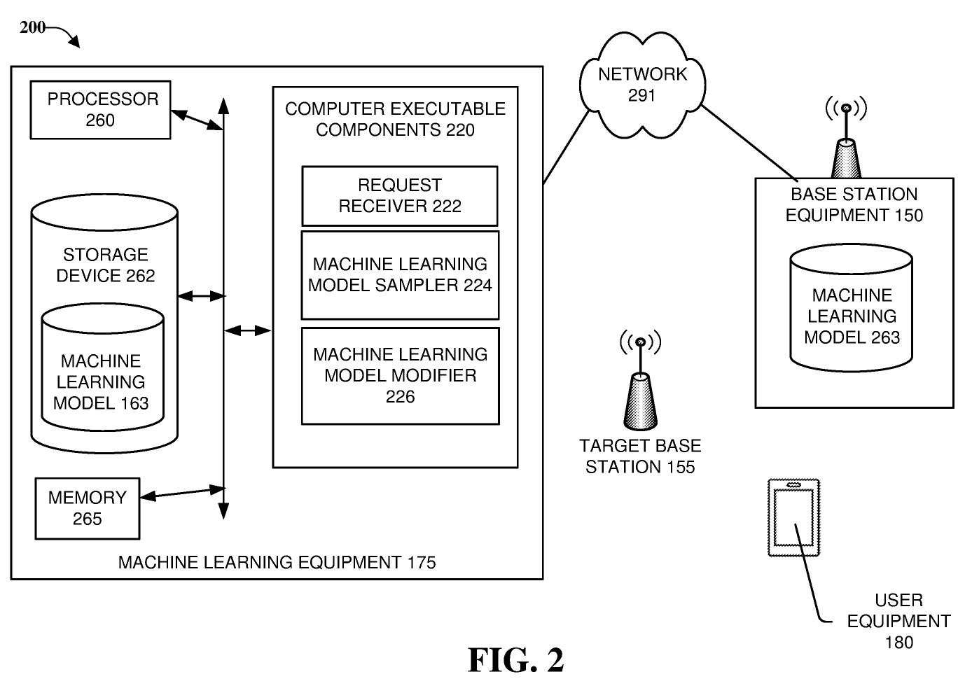

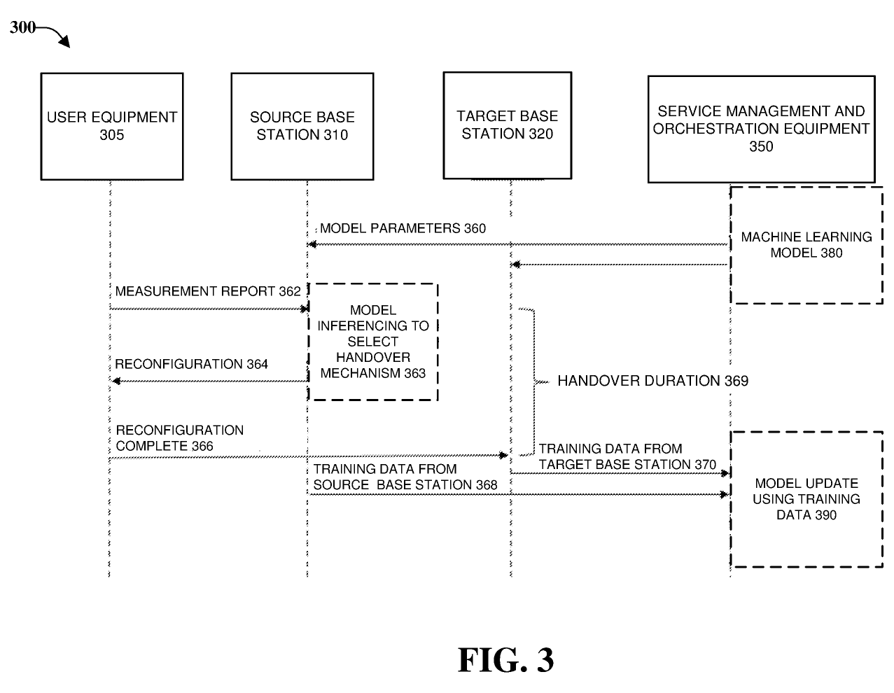

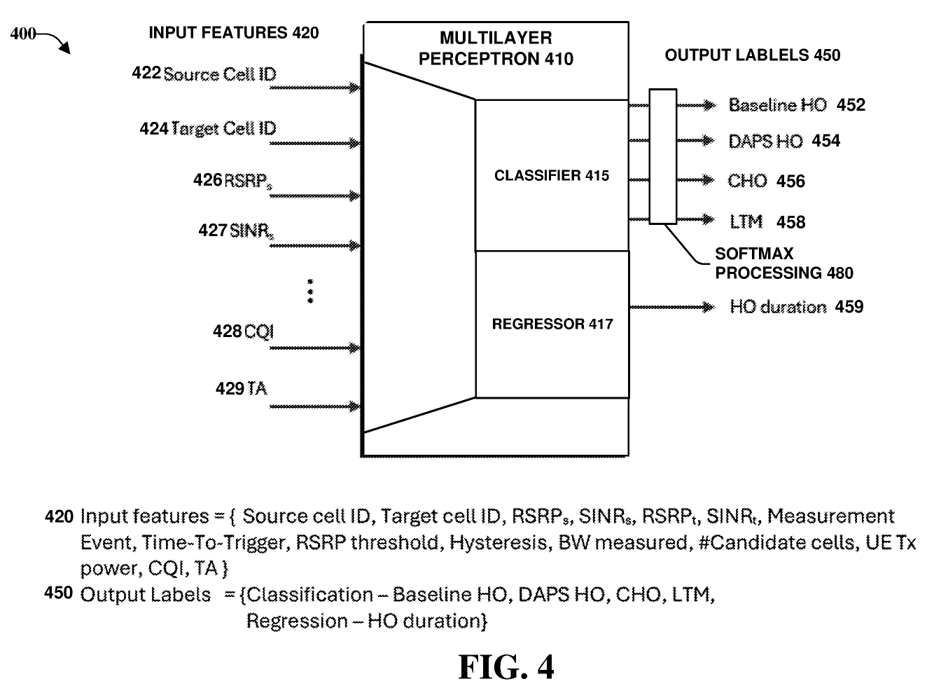

FIG. 2 is an architecture diagram of an example system 200 that can facilitate using a machine learning model to select from different mechanisms used to perform handovers between source and target base stations, in accordance with one or more embodiments. For purposes of brevity, description of like elements and/or processes employed in other embodiments is omitted. As depicted, system 200 includes machine learning equipment 175 connected, via network 290, to base station equipment 150. Machine learning equipment 175 includes processor 260, memory 265, storage device 262, and computer executable components 220. Storage device 262 includes machine learning model 163, and base station equipment includes machine learning model 263. The relationship between (centralized) machine learning model 163 and (local) machine learning model 263 is discussed further with FIGS. 3 and 4 below.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include request receiver 222, machine learning model sampler 224, machine learning model modifier 226, and other components described or suggested by different embodiments described herein, e.g., that can improve the operation of system 200, in accordance with one or more embodiments.

As discussed further with FIG. 10 below, network 290 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

In an example implementation of machine learning equipment 175, memory 265 can store executable instructions that can facilitate generation of request receiver 222, which in some implementations, may receive, from a cellular node of a radio access network, a handover request applicable to a handover of a mobile node from the cellular node to a target cellular node based on a parameter applicable to the handover, and a machine learning structure applicable to the handover. For example, one or more embodiments, request receiver 222 may receive, from base station equipment 150, a handover request applicable to a handover of user equipment 180 from the base station equipment 150 to target base station 155, based on a parameter applicable to the handover, and machine learning model 163, applicable to the handover.

In an example implementation of machine learning equipment 175, memory 265 can further store executable instructions that can facilitate generation of machine learning model sampler 224, which in some implementations, may, based on a parameter applicable to the handover, and a machine learning structure applicable to the handover: selecting a collection of reassignment processes for the handover, generating a respective likelihood of a successful handover applicable to the respective reassignment processes, and predicting a respective length of time applicable to completion of the respective reassignment processes. For example, in one or more embodiments, machine learning model sampler 224 may, based on a parameter applicable to the handover, and a machine learning model 163 applicable to the handover: selecting a collection of reassignment processes for the handover, generating a respective likelihood of a successful handover applicable to the respective reassignment processes, and predicting a respective length of time applicable to completion of the respective reassignment processes.

In an example implementation of machine learning equipment 175, memory 265 can further store executable instructions that can facilitate generation of machine learning model modifier 226, which in some implementations, may, based on a received indication applicable to the handover, modify the machine learning structure. For example, in one or more embodiments, machine learning model modifier 226 may, based on a received indication applicable to the handover, modify machine learning model 163.

For convenience of explanation, elements of FIGS. 3 and 4 are described together below. FIGS. 3 and 4 include diagrams that illustrate aspects of example systems 300 and 400, respectively that can facilitate using a machine learning model to select from different mechanisms used to perform handovers between source and target base stations, in accordance with one or more embodiments. For purposes of brevity, description of like elements and/or processes employed in other embodiments is omitted. System 300 includes user equipment 305, source base station 310, target base station 320, service management and orchestration equipment 350.

One or more embodiments may employ a machine learning model to improve the likelihood of performing a successful handover of user equipment 305 from source base station 310 to target base station 320. In an example implementation, the machine learning model may include a learning model that selects from several actions (e.g., handover mechanisms), based on a defined context, e.g., factors discussed below that affect the success of the handover operation. One or more embodiments may be implemented using components implemented within the open radio access network (RAN) architecture (O-RAN). Functions described with reference to service management and orchestration equipment 350 may be used to provide the learning model, and may be implemented within O-RAN using a RAN intelligent controller component (RIC) implementing operations, administration, and maintenance (OAM) functions.

To simplify the figure, the timeline of FIG. 3 begins an initial deployment of the machine learning model, e.g., the model being prepared with training data applicable to handovers using different handover mechanisms. In an example, training data may be generated by network simulators that may also be used for handover validation. To augment the training data, techniques such as variational autoencoder generative model (VAE). Another approach is to train the model using actual handover data, with this approach being used as described below to further train the model based on the use of embodiments.

At 360, model parameters from machine learning model 380 trained on handover data, are received by source base station 310 from service management and orchestration equipment 350. At 362, user equipment 305 provides a measurement report to source base station 310. radio resource control (RRC) measurement report. Example input features 422 includes source cell identifier (source cell ID) 422, target cell identifier (target cell ID) 424, reference signal received powers (RSRPs) 426, signal to interference plus noise ratios (SINRs) 427, channel quality indicator (CQI), and timing advance (TA). Other example input features not shown include, but are not limited to, reference signal received power of target (RSRPt), signal to interference plus noise ratio of target (SINRt), measurement event (ME), time-to-trigger (TTT), reference signal received power threshold (RSRP threshold), hysteresis (HYS), bandwidth measured (BW), number of candidate cells (#Candidate cells), and user equipment transmit power (UE Tx power).

In embodiments, particular input features 420 may be employed to address handovers by particular base station equipment. For example, useful handover mechanisms may be more difficult to determine in certain regions during a particular time of day due, e.g., based on interference. For this example, a time of day and geographical coordinates could be included in the training samples to provide additional useful inputs for particular handovers at source base station 310.

At 363, based on the received measurement report, source base station 310 performs model inferencing to a select handover mechanism. An example embodiment depicted in FIG. 4 includes an input layer of input features 420, and an output layer of output labels 450. In different implementations, multilayer perceptron 410 includes a multi-output neural network that was trained to include classifier 415 and regressor 417, e.g., as described at 360 using data based on handover procedures using different handover mechanisms. Returning to the example of FIG. 2, machine learning model 163 may correspond to machine learning model 380, e.g., implemented at service management and orchestration equipment 350, and machine learning model 163 may correspond to a model used at 363 to select a handover mechanism for a handover at source base station 310. In this example, service management and orchestration equipment 350, machine learning model 380 may be continuously updated based on data from completed handovers, and also communicates training data (e.g., weight modifications) to multiple base stations 310 to update localized machine learning models for use with 363 inferencing.

In one or more embodiments, multilayer perceptron 410 may employ a feed forward neural network architecture to reduce the inferencing complexity of providing output labels 450 with a large data set. Example input features 420 and output labels 450 are shown. In some implementations, input features 420 may be the most recent measured quantities, e.g., from the measurement report provided at 362 by user equipment 305 to source base station 310. Example output labels 450 include labels resulting from the employment of classifier 415 of multilayer perceptron 410, e.g., baseline handover mechanism (Baseline HO) 452, a dual active protocol stack handover mechanism (DAPS HO) 454, a conditional handover mechanism (CHO) 456, and a late triggering and missed handover mechanism, L1/L2 Triggered Mobility (LTM) 458.

In an example, DAPS HO 454 allows a connection to a source cell to remain active until a transmission to, and a reception from the target cell. In another example, using the CHO 456 handover mechanism, multiple candidate target cells are prepared, and a handover command is sent for each target cell along with the triggering conditions for each target cell, with the user equipment storing the respective handover commands, and performing the transfer when the triggering conditions are met for any of the configured cells. In another example LTM 458 may utilize lower level signaling to reduce the service interruption time resulting from transfers. This mechanism reserves target cell resources and sends handover commands for the UE to store, with L1 signaling being used for additional measurement reporting and to pre-synchronize the download and upload channels. It should be noted that the various handover mechanisms described herein are not limiting, and embodiments may be used with additional handover mechanisms known now and developed in the future.

As depicted in FIG. 4, after classifier 415 produces labels, Softmax processing 480 may be used to provide output labels 450. In embodiments, Softmax processing 480 may be employed to reduce cross-entropy loss in the provision of output labels 450, e.g., cross-entropy loss may be reduced based on class probabilities provided for different mechanisms by Softmax processing 480.

Example output labels 450 may further include labels resulting from the employment of regressor 417, e.g., predicted handover duration 459. In one or more embodiments, this prediction is related to a duration for which additional network resources are reserved for user equipment 305 until the handover procedure is completed. In one or more embodiments, the predicted handover duration 459 (e.g., service interruption time) may be used to select from different inferred handover mechanisms. For example, if the predicted mechanism is not supported by user equipment 305, the mechanism with the next lower interruption time is selected. e.g., mechanisms listed from shortest time to longest time: DAPS HO 454, LTM 458, CHO 456, and Baseline HO 452.

At 364, the selected handover mechanism is provided to user equipment 305 for reconfiguration of a handover to target base station 320. In an example, the selected handover mechanism may be employed during a handover preparation phase to configure the target cell, which in turn provides a user equipment configuration that the user equipment 305 uses. In an implementation, this user equipment configuration may be passed as a handover command to user equipment 305 through the current cell using a RRC reconfiguration procedure.

At 366, the reconfiguration is completed and, based on the selected mechanism, target base station 320 is configured for the handover, and user equipment 305 employs the selected handover mechanism to transfer to target base station 320. A handover duration 369 may be determined based on a time the handover mechanism was selected at 363 and the completion of the handover at 366.

In embodiments, after use of the predictions sampled from machine learning model 380 to perform a handover, different data relevant to the handover and results of the handover may be used to further train the machine learning model. For example, at 370, based on the handover of user equipment 305 from source base station 310 to target base station 320, training data from target base station 320 is provided to service management and orchestration equipment 350. At 368, based on the handover of user equipment 305 from source base station 310 to target base station 320, training data from source base station 310 is provided to service management and orchestration equipment 350. At 390, based on the training data received from source base station 310 and target base station 320, service management and orchestration equipment 350 updates machine learning model 380.

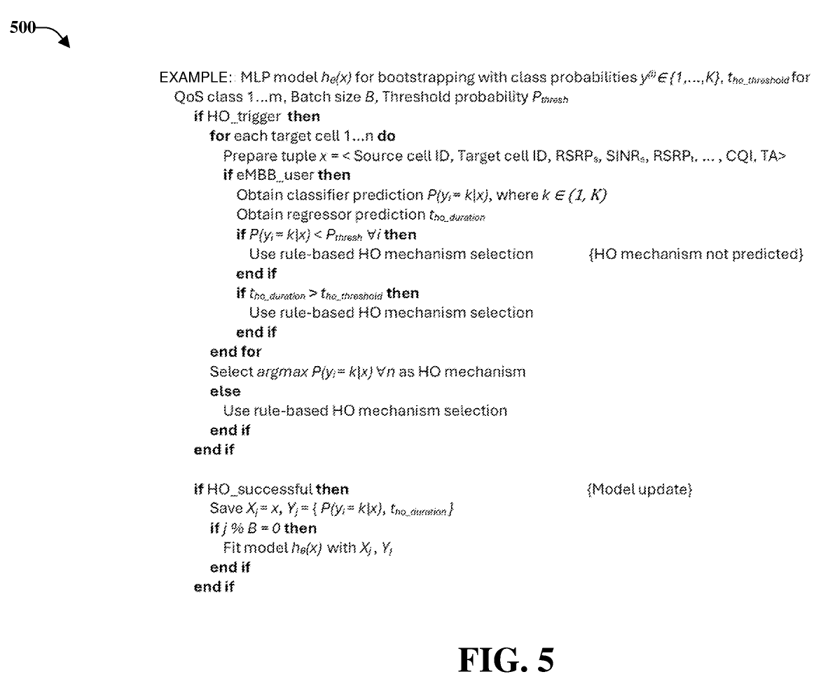

FIG. 5 includes pseudocode 500 that may be used by embodiments to facilitate using a machine learning model to select from different mechanisms used to perform handovers between source and target base stations, in accordance with one or more embodiments. Repetitive description of like elements employed in one or more embodiments described herein is omitted for sake of brevity.

As shown in pseudocode 500, execution is commenced by the detection of a handover trigger, e.g., a based on the RRC measurement report. As shown pseudocode 500 the inputs to the process include the trained model that is used for bootstrapping, an empirically determined threshold duration for each quality of service (QoS) class, the batch size for model updates, and the threshold probability for the predicted HO mechanism to be considered valid.

As shown, the trained model is used to predict the probabilities for each class (HO mechanism) along with the HO duration for the highest probability class, for each target cell. If the class probabilities are lower than a threshold Pₜₕᵣₑₛₕ, the algorithm falls back to a rule-based selection. The predicted HO duration from the regressor may also be used to check against a threshold duration tho_threshold, e.g., when the HO is predicted to take too long, then the rule-based selection is used.

As shown in pseudocode 500, if all the conditions are satisfied, the HO mechanism with the maximum predicted probability and the associated target cell is selected. In this example, after use of the selected HO mechanism, if the outcome of the HO is successful, the parameters are saved for batch training. In embodiments, the machine learning model may be updated periodically in mini batches using the saved successful HO samples.

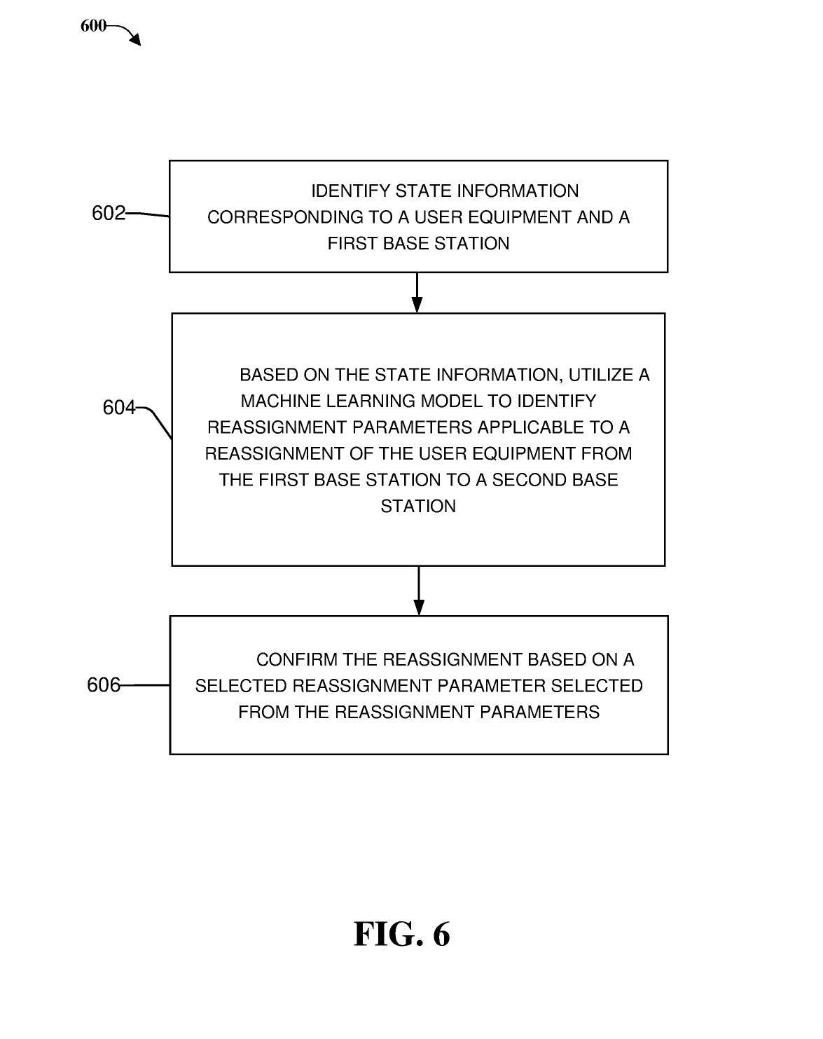

FIG. 6 depicts a flow diagram representing example operations of an example method 600 that can facilitate using a machine learning model to select from different mechanisms used to perform handovers between source and target base stations, in accordance with one or more embodiments. For purposes of brevity, description of like elements and/or processes employed in other embodiments is omitted.

In some examples, one or more embodiments of method 600 can be implemented by state identifier 122, reassignment parameter identifier 124, reassignment confirmer 126, and other components that can be used to implement aspects of method 600, in accordance with one or more embodiments. FIG. 6, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 602 of method 600, state identifier 122 of base station equipment 150 can identify state information corresponding to a user equipment and a first base station. At 604 of method 600, reassignment parameter identifier 124 can, based on the state information, utilize a machine learning model to identify reassignment parameters applicable to a reassignment of the user equipment from the first base station to a second base station. At 606 of method 600, reassignment confirmer 126 can confirm the reassignment based on a selected reassignment parameter selected from the reassignment parameters.

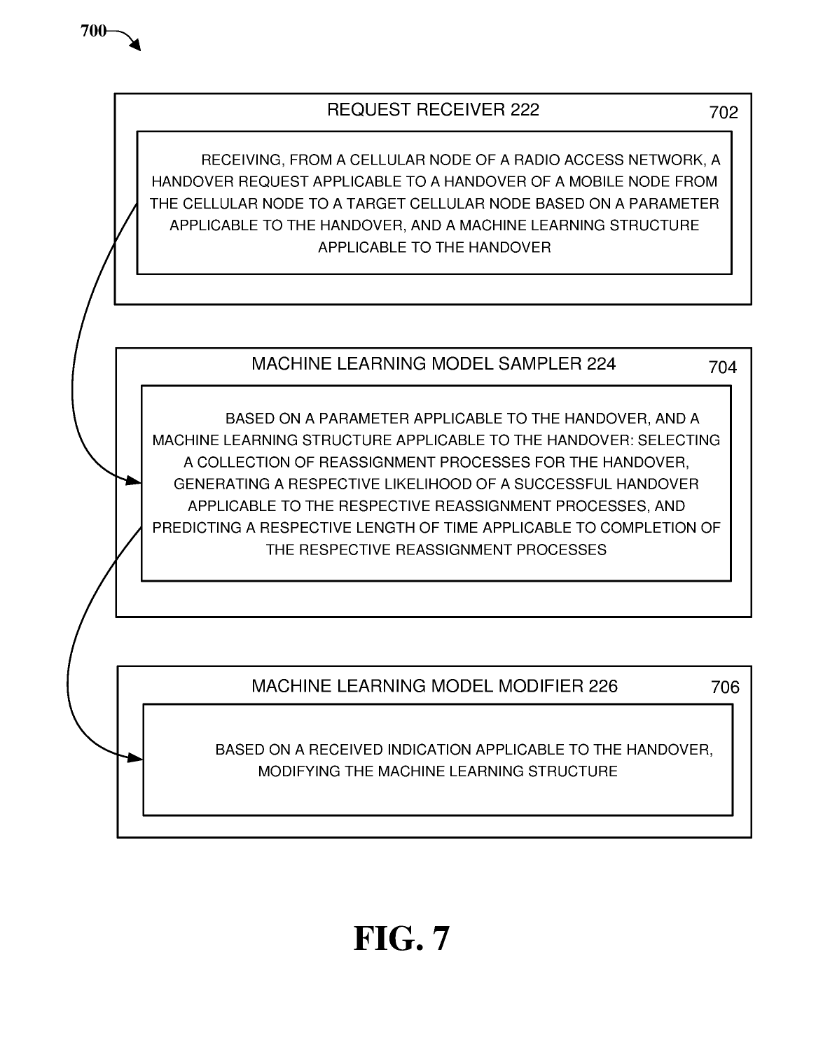

FIG. 7 depicts an example system 700 that can facilitate using a machine learning model to select from different mechanisms used to perform handovers between source and target base stations, in accordance with one or more embodiments. For purposes of brevity, description of like elements and/or processes employed in other embodiments is omitted.

System 700 includes at least one memory that stores computer executable components, and at least one processor that executes the computer executable components stored in the at least one memory, with the computer executable components including request receiver 222, machine learning model sampler 224, machine learning model modifier 226, and other components that can be used to implement aspects of system 700, as described herein, in accordance with one or more embodiments.

At 702 of FIG. 7, request receiver 222 can receive, from a cellular node of a radio access network, a handover request applicable to a handover of a mobile node from the cellular node to a target cellular node based on a parameter applicable to the handover, and a machine learning structure applicable to the handover. At 704 of FIG. 7, machine learning model sampler 224 can, based on a parameter applicable to the handover, and a machine learning structure applicable to the handover: select a collection of reassignment processes for the handover, generate a respective likelihood of a successful handover applicable to the respective reassignment processes, and predict a respective length of time applicable to completion of the respective reassignment processes. At 706 of FIG. 7, machine learning model modifier 226 can based on a received indication applicable to the handover, modify the machine learning structure.

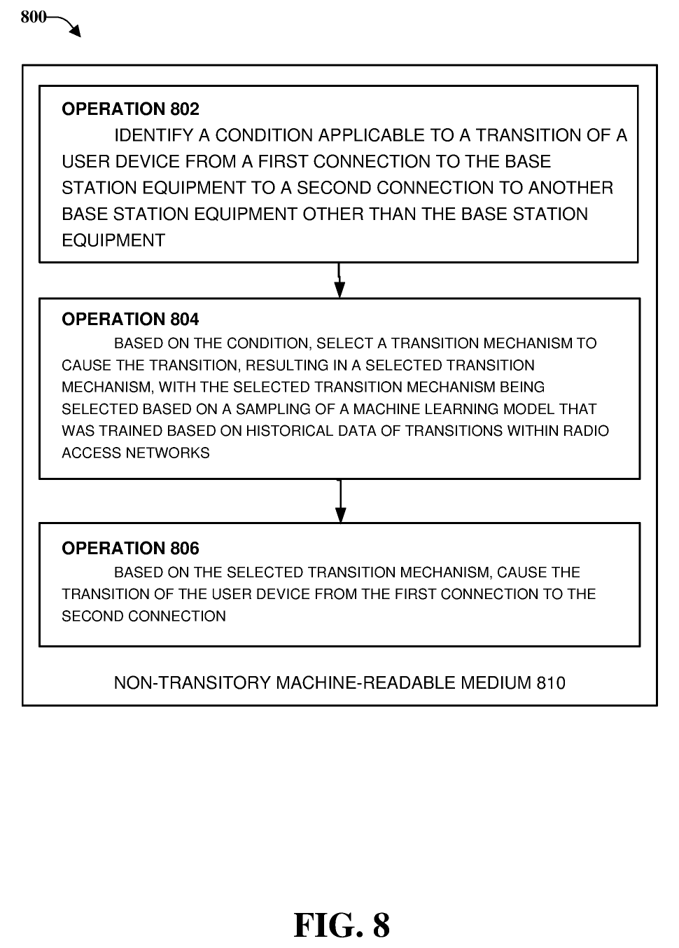

FIG. 8 depicts an example 800 non-transitory machine-readable medium 810 that can include executable instructions that, when executed by a processor of a system, can facilitate using a machine learning model to select from different mechanisms used to perform handovers between source and target base stations, in accordance with one or more embodiments. For purposes of brevity, description of like elements and/or processes employed in other embodiments is omitted.

As depicted, non-transitory machine-readable medium 810 includes executable instructions that, when executed by at least one processor of a machine learning device, facilitate performance of operations that include operation 802 which can identify a condition applicable to a transition of a user device from a first connection to the base station equipment to a second connection to another base station equipment other than the base station equipment. The operations may further include operation 804 which can, based on the condition, select a transition mechanism to cause the transition, resulting in a selected transition mechanism, with the selected transition mechanism being selected based on a sampling of a machine learning model that was trained based on historical data of transitions within radio access networks. The operations may further include operation 806 which can, based on the selected transition mechanism, cause the transition of the user device from the first connection to the second connection.

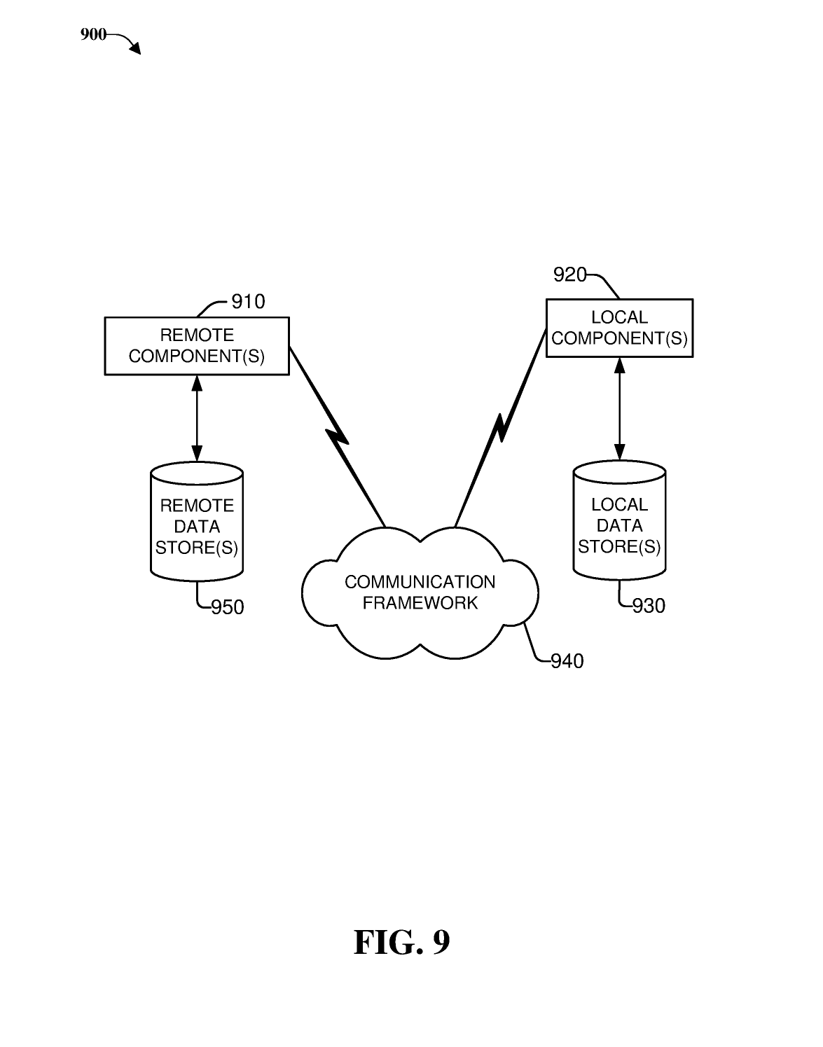

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, RAN devices, gateway devices, femtocell devices, servers, etc. The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, machine learning structures, etc. that perform particular tasks and/or implement particular abstract data types.

In the subject specification, terms such as "store," "storage," "data store," "data storage," "database," and substantially any other information storage component relevant to operation and functionality of a component, refer to "memory components," or entities embodied in a "memory" or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in different systems, e.g., both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer executable instructions that can run on one or more computers, those skilled in the art will recognize that the embodiments can also be implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips…), optical discs (e.g., CD, DVD…), smart cards, and flash memory devices (e.g., card, stick, key drive…). Of course, those skilled in the art will recognize many modifications can be made to this configuration without departing from the scope or spirit of the various embodiments.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service "execution" may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine Audio/Video (AV) Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) RAN or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such features may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive - in a manner similar to the term “comprising” as an open transition word - without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
identifying, by computer equipment comprising at least one processor, state information corresponding to a user equipment and a first base station;
based on the state information, utilizing, by the computing equipment, a machine learning model to identify reassignment parameters applicable to a reassignment of the user equipment from the first base station to a second base station; and
confirming, by the computer equipment, the reassignment based on a selected reassignment parameter selected from the reassignment parameters.

2. The method of claim 1, wherein the state information comprises an indication to perform the reassignment.

3. The method of claim 1, wherein the respective reassignment parameters comprise a handover parameter applicable to the reassignment, and wherein the selected reassignment parameter comprises the handover parameter.

4. The method of claim 3, wherein the handover parameter comprises at least one of:
a baseline handover parameter,
a dual active protocol stack handover parameter,
a conditional handover parameter, or
a triggered handover parameter triggered by a measurement at a communication layer.

5. The method of claim 3, wherein the respective reassignment parameters further comprise respective probabilities of success of the respective reassignment parameters.

6. The method of claim 5, wherein the selected handover mechanism was selected based on a probability of success of the selected handover mechanism.

7. The method of claim 3, wherein the respective reassignment parameters further comprise a predicted duration of the reassignment as a result of employing the handover parameter applicable to the reassignment.

8. The method of claim 7, wherein the selected reassignment parameter was selected further based on the predicted duration of the reassignment.

9. The method of claim 8, further comprising, based on the predicted duration of the reassignment, reserving, by the computer equipment, a supplemental network resource applicable to supporting the user equipment during the reassignment.

10. The method of claim 7, wherein the predicted duration of the reassignment comprises a duration from a time the selected reassignment parameter is selected to a completion of the reassignment.

11. The method of claim 7, wherein the selected reassignment parameter was selected further based on:
a quality of service requirement applicable to communication subject to the reassignment, and
the predicted duration of the reassignment being within the quality of service requirement.

12. The method of claim 3, wherein the selected reassignment parameter was selected further as a result of a determination that the user equipment had a capability to utilize the selected reassignment parameter.

13. The method of claim 1, wherein the state information comprises at least one of:
a first characteristic representative of a source cell identifier of the first base station,
a second characteristic representative of a signal-to-noise ratio,
a third characteristic representative of a reference signal received power of the first base station,
a fourth characteristic representative of a signal-to-interference-plus-noise ratio,
a fifth characteristic representative of a characteristic representative of a measurement event threshold,
a sixth characteristic representative of a characteristic representative of a time-to-trigger,
a seventh characteristic representative of a reference signal received power threshold,
an eighth characteristic representative of hysteresis,
a ninth characteristic representative of a measured bandwidth,
a tenth characteristic representative of transmission power of the user equipment,
an eleventh characteristic representative of a channel quality indicator,
a twelfth characteristic representative of a timing advance feedback indicator,
a thirteenth characteristic representative of a target cell identifier,
a fourteenth characteristic representative of a reference signal received power of the second base station, or
a fifteenth characteristic representative of a number of candidate cells.

14. A computing system, comprising:
at least one memory that stores computer executable instructions; and
at least one processor configured to process the computer executable instructions that, when executed by the at least one processor, facilitate performance of operations, comprising:
receiving, from a cellular node of a radio access network, a handover request applicable to a handover of a mobile node from the cellular node to a target cellular node;
based on a parameter applicable to the handover, and a machine learning structure applicable to the handover:
selecting a collection of reassignment processes for the handover,
generating a respective likelihood of a successful handover applicable to the respective reassignment processes, and
predicting a respective length of time applicable to completion of the respective reassignment processes; and
based on a received indication applicable to the handover, modifying the machine learning structure.

15. The computing system of claim 14, wherein the machine learning structure was trained based on historical data of the radio access network applicable to uses of the collection of reassignment processes, and wherein the operations further comprise:
receiving the machine learning structure from core management equipment of the radio access network.

16. The computing system of claim 14, wherein the machine learning structure comprises multi-output neural network comprising a classifier and a regressor, wherein the generating of the respective likelihood of the successful handover comprises employing the classifier to generate the respective likelihoods, and wherein the predicting of the respective length of time applicable to the respective handover processes comprises employing the regressor to predict the respective lengths of time.

17. The computing system of claim 14, wherein the received indication comprises weight magnitude data, wherein the modifying of the machine learning structure comprises further training the machine learning structure based on the weight magnitude data, and wherein the received indication was received from at least one of:
the cellular node,
the target cellular node, or
the mobile node.

18. The computing system of claim 14, wherein the received indication comprises information representative of a result of the cellular node employing a selected reassignment process of the collection of reassignment processes, and wherein the cellular node selected the selected reassignment process based on at least one of:
the respective likelihood of the successful handover generated for the selected reassignment process, and
the respective length of time predicted for the completion of the selected reassignment process.

19. A non-transitory machine-readable medium comprising executable instructions that, when executed by at least one processor of base station equipment of a radio access network, facilitate performance of operations, the operations comprising:
identifying a condition applicable to a transition of a user device from a first connection to the base station equipment to a second connection to another base station equipment other than the base station equipment;
based on the condition, selecting a transition process to cause the transition, resulting in a selected transition process, wherein the selected transition process was selected based on a sampling of a machine learning model that was trained based on historical data of transitions within radio access networks; and
based on the selected transition process, causing the transition of the user device from the first connection to the second connection.

20. The non-transitory machine-readable medium of claim 19, wherein the machine learning model comprises a feed forward neural network.
